(19) United States
(12) Patent Application Publication
(10) Pub. No.: US 2014/0361101 A1
(43) Pub. Date: Dec. 11, 2014

(54) PERSONAL MISTING DEVICE

(71) Applicant: RealXGear, Melissa, TX (US)

(72) Inventor: Chris Maher, Anna, TX (US)

(73) Assignee: RealXGear, Melissa, TX (US)

(21) Appl. No.: 14/062,391

(22) Filed: Oct. 24, 2013

Related U.S. Application Data
(60) Provisional application No. 61/831,991, filed on Jun. 6, 2013.

(51) Int. Cl. B05B 9/04

(52) U.S. Cl. CPC B05B 9/0426
USPC 239/302

(57) ABSTRACT

In one example, a personal misting device is provided that includes a portable housing sized and configured to be held in one hand of a user, and also includes a fluid reservoir attachable to the portable housing. A fluid pump and motor are disposed within the portable housing, and the fluid pump is configured and arranged for fluid communication with the fluid reservoir. Additionally, a hose is provided that has a first end in fluid communication with the fluid pump, and a second end that is connected to a misting nozzle. Finally, a power supply operable to run the fluid pump is disposed in the housing.

### RELATED APPLICATIONS

This application hereby claims priority to U.S. Provisional Patent Application Ser. No. 61/831,991, entitled PERSONAL MISTING DEVICE, and filed Jun. 6, 2013. The aforementioned application is incorporated herein in its entirety by this reference.

### BACKGROUND

The present disclosure is generally concerned with devices that may facilitate regulation of the personal climate or environment of a user. More specifically, the disclosed embodiments concern a personal misting device that may provide a cooling effect to a user.

### BRIEF SUMMARY OF SOME ASPECTS OF THE DISCLOSURE

Disclosed embodiments are generally concerned with a personal misting device that may provide a cooling effect to a user by providing a flow and/or burst of water mist.

It should be noted that the embodiments disclosed herein do not constitute an exhaustive summary of all possible embodiments, nor does this brief summary constitute an exhaustive list of all aspects of any particular embodiment(s). Rather, this brief summary simply presents selected aspects of some example embodiments. It should be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should such embodiments be construed to implement, or be limited to implementation of, any particular technical effect(s) or solution(s).

Embodiments within the scope of this disclosure may include any one or more of the following elements, and features of elements, in any combination: a portable housing sized to be held within the hand of a user, in a beach bag, backpack, or in a golf cart, for example; a housing where one example size of the housing is about 75 mm in diameter and between about 175 mm to about 225 mm in length; a rechargeable battery configured to reside within a housing, an example of which is a lithium (Li) battery; a battery that may hold a charge for up to about 7 hours of use; one or more photovoltaic devices, such as one or more solar panels, small enough to be installed in or on a housing and operable to power a pump; a battery rechargeable by a vehicle cigarette lighter connection; an AC electrical adapter that can provide power to a pump; an on/off switch to control the operation of a pump; low battery indicator such as a light or sound; a clip, hang hole, and/or other structure(s), on a housing where the clip, hang hole and/or other structure(s) enables the housing to be detachably connected to a user's clothing or equipment or other element(s) to enable hands-free operation; an internal pump reservoir configured to reside within a housing; a supply hose that is releasably connectible to a water supply such as a pump reservoir or external reservoir, and a pump; an external reservoir, such as a hydration bladder for example, connectible to a pump; a pump capable of output in a range of about 120 psi to about 300 psi; a pump sufficiently small that, for example, it could be placed in a user's pocket or readily held in the palm of a user's hand; a pump capable of an output in a range of about 108 psi to about 145 psi (or about 7.5 bar to about 10 bar); a hydration bladder connectible to a pump and having a capacity in a range of about 2 liters to about 6 liters of fluid; a pump that may run up to about 7 hours before an associated battery must be recharged; hoses, including a semi-rigid hose permanently or detachably connected to a housing and configured for fluid communication with a pump disposed within the housing; a semi-rigid hose that may have length of between about 2 feet and about 4 feet; a semi-rigid hose that may be perforated to allow mist to escape from the perforations; one or more misting nozzles in fluid communication with a pump; a misting nozzle of between about 0.2 mm and about 0.5 mm diameter; a set of misting nozzles, each having a different diameter; a misting nozzle connectible to, or included in, a semi-rigid hose, or in a housing; and, a kit including one or more of, a personal misting device as disclosed herein, a hydration bladder with or without a drinking tube/valve, a hose for connecting the hydration bladder to the personal misting device, one or more misting nozzles, a battery charger, an AC adapter, and a pack for carrying a hydration bladder.

None of the foregoing elements should be interpreted to be an essential or critical element, and other embodiments may omit one or more of any of the foregoing elements while remaining within the scope of the invention. Moreover, the aforementioned elements may not be mutually exclusive and, as such, more than one of those elements could be included in a single embodiment.

### BRIEF DESCRIPTION OF THE DRAWINGS

The appended drawings contain figures of some example embodiments to further clarify various aspects of the present disclosure. It will be appreciated that these drawings depict only some embodiments of the disclosure and are not intended to limit its scope in any way. The disclosure will be described and explained with additional specificity and detail through the use of the accompanying drawings in which:

FIG. 1 is side view of an example embodiment of a personal misting device showing the housing and an attached reservoir;

FIG. 2 is a partial side view of an example embodiment of a personal misting device showing the housing;

FIG. 3 is an upper perspective view of an example embodiment of a personal misting device showing the housing and an attached reservoir;

FIG. 4 is another side view of an example embodiment of a personal misting device showing the housing and an attached reservoir;

FIG. 5 is a top view of an example embodiment of a personal misting device;

FIG. 6 is another upper perspective view of an example embodiment of a personal misting device showing the housing and an attached reservoir;

FIG. 7 is a partial perspective view of the housing of an example embodiment of a personal misting device;

FIG. 8 is a section view of the housing of an example embodiment of a personal misting device;

FIG. 9 is another section view of the housing of an example embodiment of a personal misting device;

FIG. 10 is a section view of the housing and disclosing an example arrangement of a pump, motor, and battery;

FIG. 11 is another section view of the housing and disclosing an example arrangement of a pump, motor, and battery;

FIG. 12 is an upper perspective section view of the housing and disclosing an example arrangement of a pump, motor, and battery;

FIG. 13 is an upper perspective view of an example pump and motor;

FIG. 14 is a side view of an example pump and motor;

FIG. 15 is a perspective view of an example tube and misting nozzle;

FIG. 16 is another perspective view of an example tube and misting nozzle; and

FIG. 17 is a rear view of an example pack for carrying one or more personal misting devices.

### DETAILED DESCRIPTION OF SOME EXAMPLE EMBODIMENTS

The present disclosure is generally concerned with devices that may facilitate regulation of the personal climate or environment of a user. More specifically, the disclosed embodiments concern a personal misting device, and associated components and equipment, that may be used to provide a cooling effect to a user or users. Embodiments of the personal misting device may be advantageous in view of their relatively small size, portability and self-contained configuration. Such attributes may contribute to the usability and effectiveness of the personal misting device and can thus enable a user to achieve some relief from hot weather or environmental conditions, indoors or out, where other sources of cooling are impractical to use and/or are unavailable.

A. General Aspects of Some Example Embodiments

In general, one or more embodiments of the personal misting device may be self-contained in that they do not, or need not, rely on an outside source of power or fluid to provide a cooling effect for a user. To illustrate, one example embodiment of the personal misting device may include a housing in which a pump and power source reside. This example of the personal misting device also includes a fluid reservoir which, in some examples, is attached to the housing, and is arranged for fluid communication with the pump. Because the misting fluid reservoir and the power supply for the pump are included elements of this example of the personal misting device, the personal misting device is self-contained and can be transported to, and used at, virtually any location without being tethered to a power supply or to a supply of misting fluid. Moreover, because the battery may be rechargeable, and the fluid reservoir refillable, the usability of the personal misting device may be enhanced, since recharging power sources, and sources of water, are often readily available.

As well, the small size of the personal misting device enables it to be employed by a user to generate and direct a flow of mist without disturbing others who may be nearby. The relatively quiet operation of embodiments of the personal misting device also contributes to its unobtrusiveness. Moreover, the portability of the personal misting device enables a user to generate a flow of mist for the user wherever the user is located, and does not require the user to go to a particular location to achieve a desired cooling effect. Further, the ready portability and small size of the personal misting device enable it to be effectively employed in environments, such as on a golf course or at a baseball or football game for example, where a user would otherwise be unlikely to have access to the cooling effects provided by the mister. As well, the portability of the personal misting device also enables it to be readily shared among a plurality of users in a group.

B. Particular Aspects of Some Example Embodiments

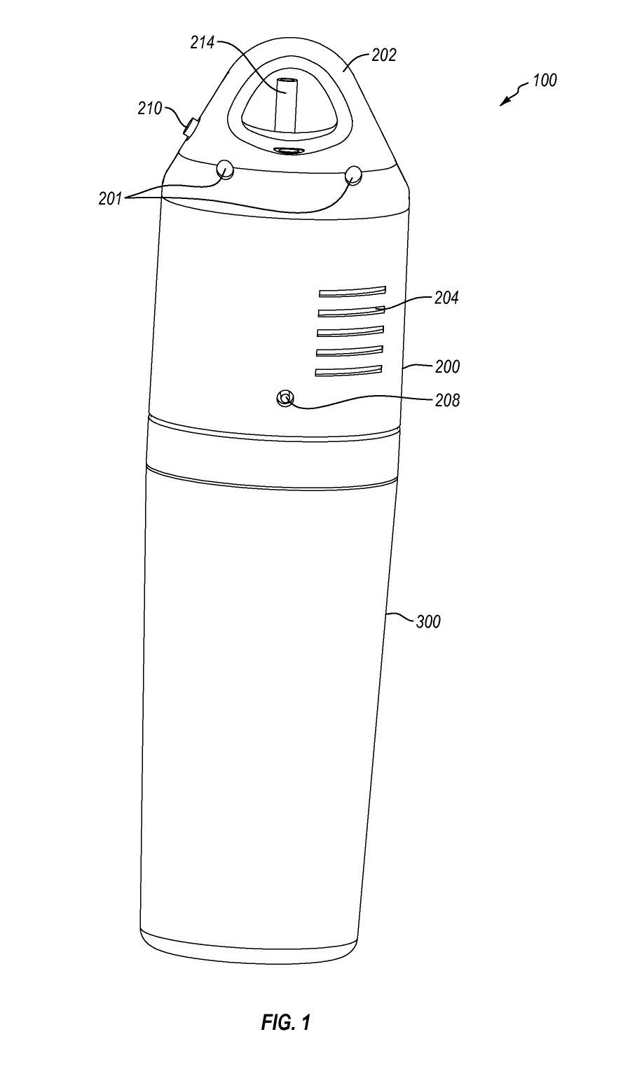

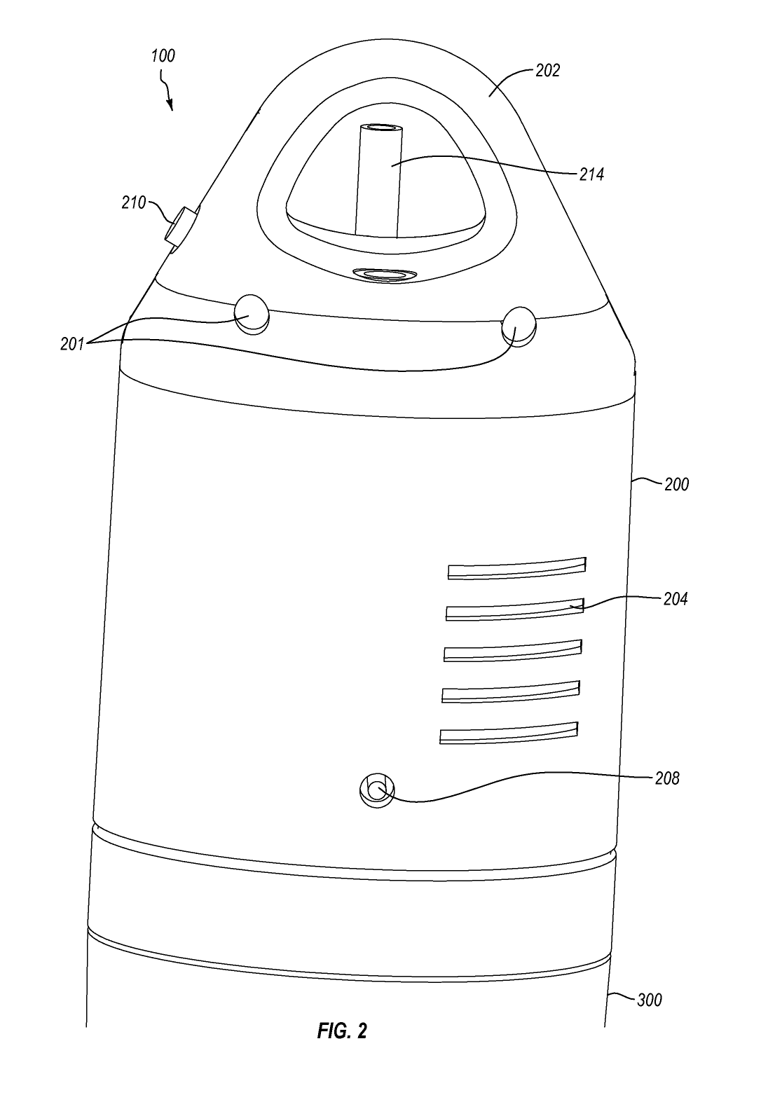

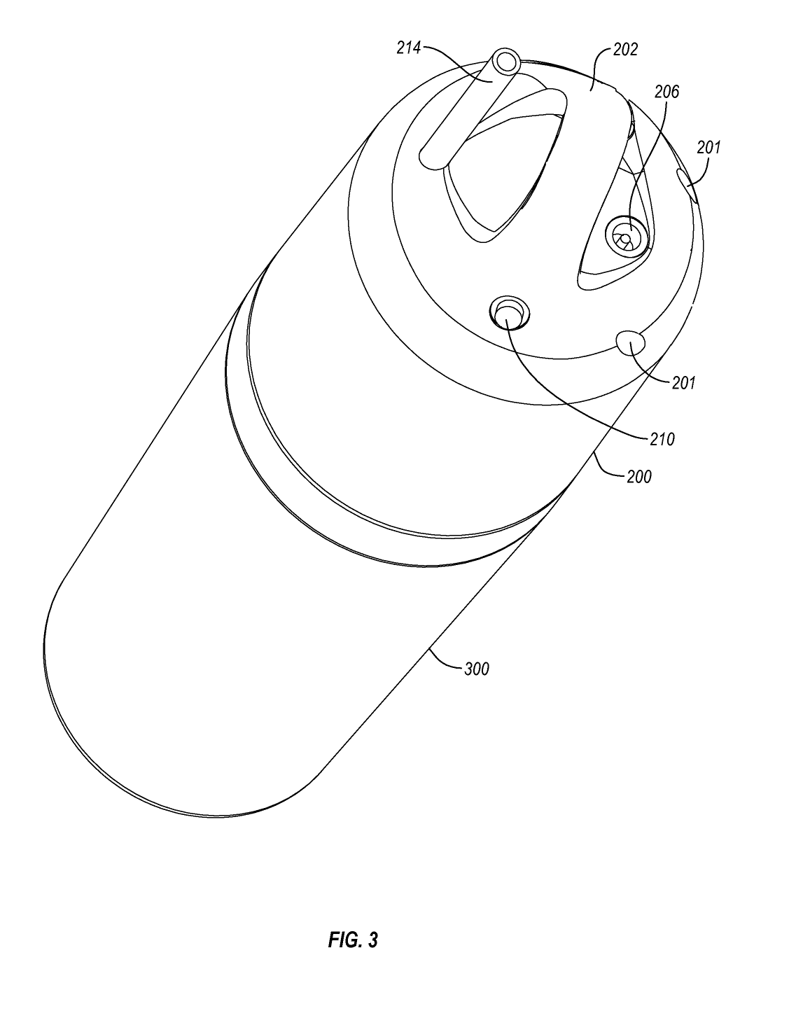

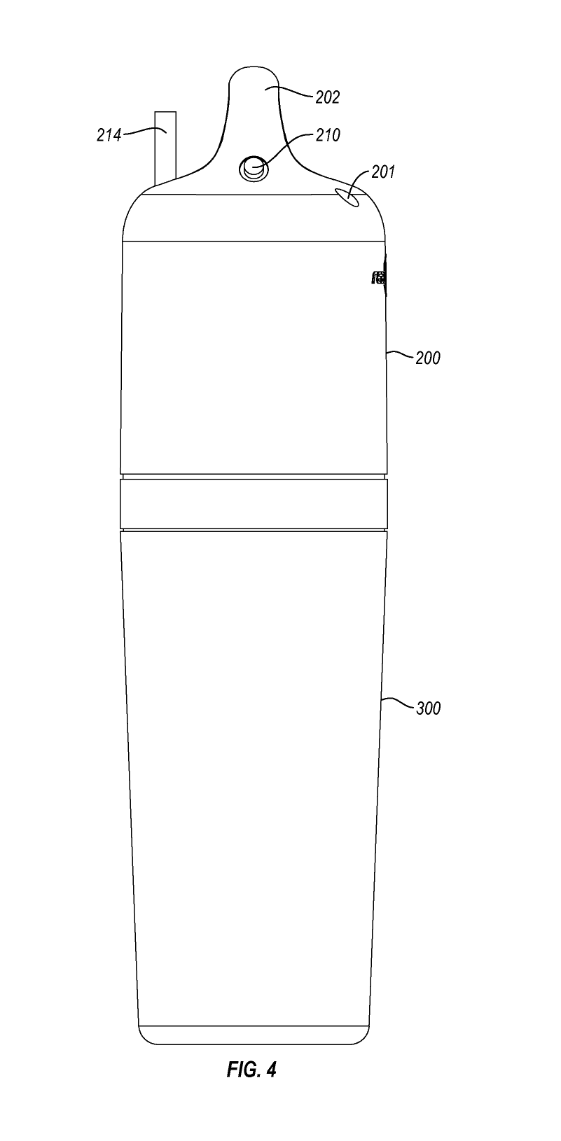

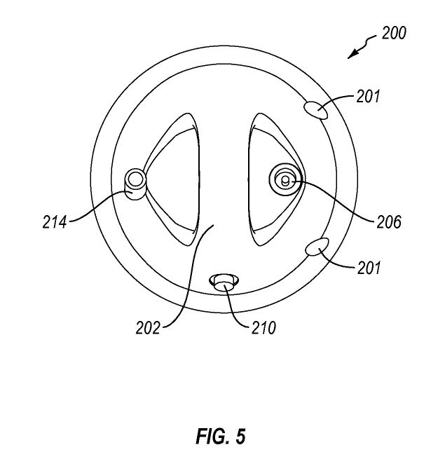

Directing attention first to FIGS. 1-6, aspects of an example embodiment of a personal misting device 100 are disclosed. As indicated in the example disclosed in FIGS. 1-6, the personal misting device 100 may include a housing 200 to which is removably attached a reservoir 300 that is configured to hold a volume of a fluid, such as water. The housing 200 may be generally bullet-shaped, although that is not necessary, and can be a single piece of material or, alternatively, may comprise a plurality of pieces that define holes 201 configured to receive fasteners (not shown), such as screws for example. The portion of the hole 201 in one side of the housing 200 may be a through hole that communicates with a corresponding threaded portion of the hole 201 in an opposing side of the housing such that as a fastener residing in the hole 201 is tightened, the two halves of the housing 200 are drawn together.

As well, a carrying sleeve or other similar device, which may comprise neoprene for example, may be provided that is sized and configured to removably receive the personal misting device 100. The carrying sleeve can include pockets or other storage to hold, for example, extra nozzles, and a nozzle cleaning device.

The housing 200 and/or reservoir 300 may be made of plastic and/or other suitable material(s). The reservoir 300 may screw onto the housing 200, or otherwise be removably attached to the housing 200, such as by a twist-lock configuration for example, or a releasable tab configuration. In some instances, the housing 200 and reservoir 300 are connected by a tether (not shown).

The reservoir 300 may be insulated, or may comprise a vacuum bottle type of configuration, so as to keep any contained fluid relatively cold for a relatively longer period of time than would otherwise be the case. In this regard, it should be noted that the reservoir may be used to contain a combination of water and ice, which may provide an enhanced cooling effect to a user. The reservoir 300 can be sized for any desired fluid capacity. In one example, the reservoir 300 holds about 600 ml, but reservoirs of larger, or smaller, capacity can alternatively be employed. As well, the reservoir 300 and/or the housing 200 may include one or more sealing elements (not shown), such as a gasket or O-ring for example, to aid in the prevention of leakage from the reservoir 300. Further, the reservoir 300 may include an external gauge or other indicator (not shown) that provides a visual indication to a user as to how much fluid is left in the reservoir 300. In some instances, such as where the reservoir is at last partly transparent for example, such an indicator may not be needed. Finally, the reservoir 300 and/or the housing 200 may include a vacuum relief device (not shown) to substantially prevent formation of a vacuum in the reservoir when fluid is being removed from the reservoir during a misting process.

With continuing reference to FIGS. 1-6, the housing 200 of the personal misting device 100 may include a variety of elements. In the example disclosed in the Figures, the housing 200 may include, among other things, a hang hole 202 and/or other means for releasably connecting the housing 200 to, for example, a user's clothing, a golf cart, a chair, or a backpack. A hang hole 202, or other such means, can additionally or alternatively be located on the reservoir 300. The housing 200 may include a hook-and-loop material, such as Velcro® for example, to enable the personal misting device 100 to be removably attached to a corresponding patch of material on a user's clothing or pack. Finally, the housing 200 may be sized to fit in a cup holder such as is commonly found in cars, boats, and elsewhere. By way of illustration, where several personal misting devices 100 are desired to be used, such as in a dugout at a baseball or softball field for example, they can be fitted into cup holders attached to the dugout fence.

In some embodiments, the housing 200 includes one or more vents 204, or comparable elements, may be provided in the housing 200 so as to enable heat generated by operation of the pump (discussed below) to escape the housing 200. This construction of the housing 200 may extend the life of the pump and/or may help the pump operate more efficiently and effectively in warm weather or climatic conditions, indoors or out.

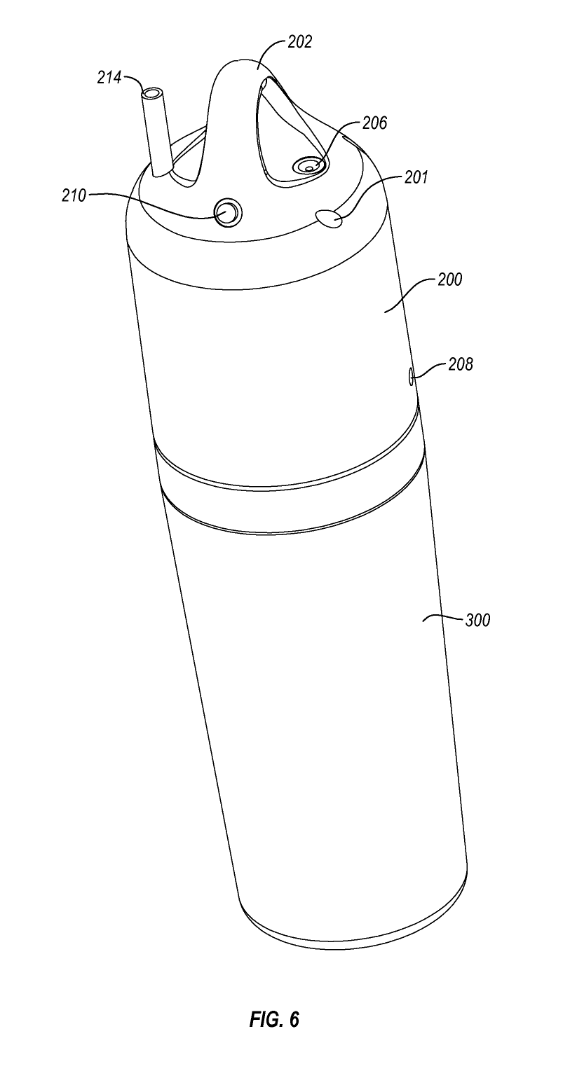

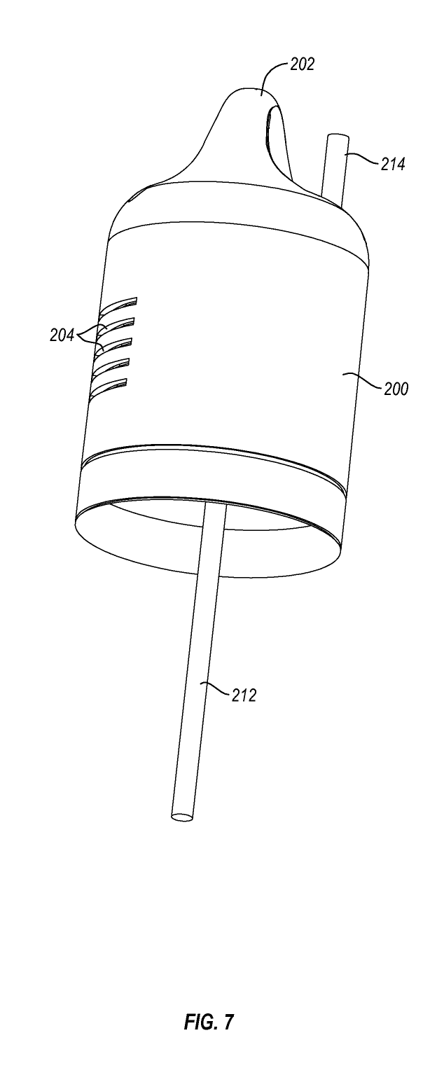

The housing 200 may also include various elements related to the operation and control of components such as the pump. For example, the housing 200 may include a charging connection 206 by way of which a battery charger (not shown) can be releasably connected to a battery (discussed below). As another example, at least some embodiments of the personal misting device 100 may include an electrical AC adapter connection 222 in the housing 200. As a final example, the housing 200 may include an on-off switch 210 which can enable a user to operate the pump so as to generate a flow of fluid from the reservoir 300, by way of a fluid inlet connection 212, and out of the personal misting device 100 through an outlet 214, as indicated in FIG. 7 for example. The fluid inlet connection 212 can take the form of a rigid or semi-rigid hose or tube. Where the fluid connection 212 is only semi-rigid and retains some degree of pliability, the lower end of the fluid connection 212 may be weighted so that it remains positioned near the bottom of reservoir 300. The outlet 214 can be an integrally formed portion of the housing 200.

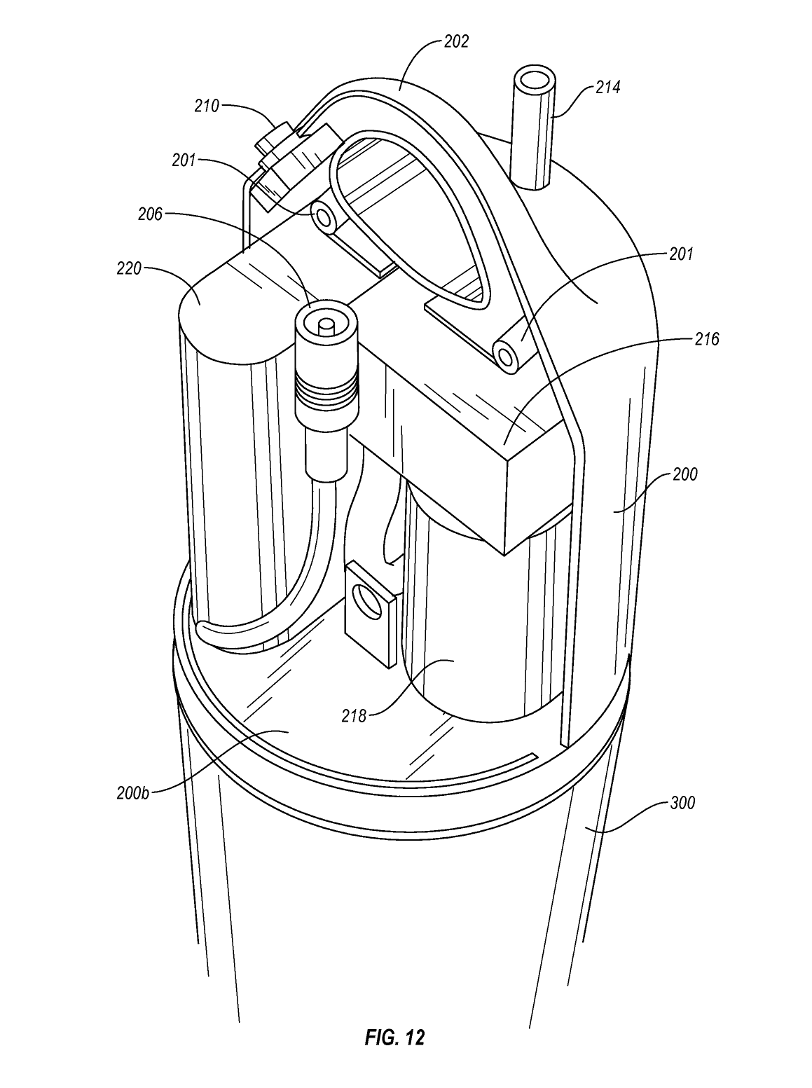

Directing attention now to FIGS. 7-14, details are provided concerning aspects of the interior construction and components of the personal misting device 100.

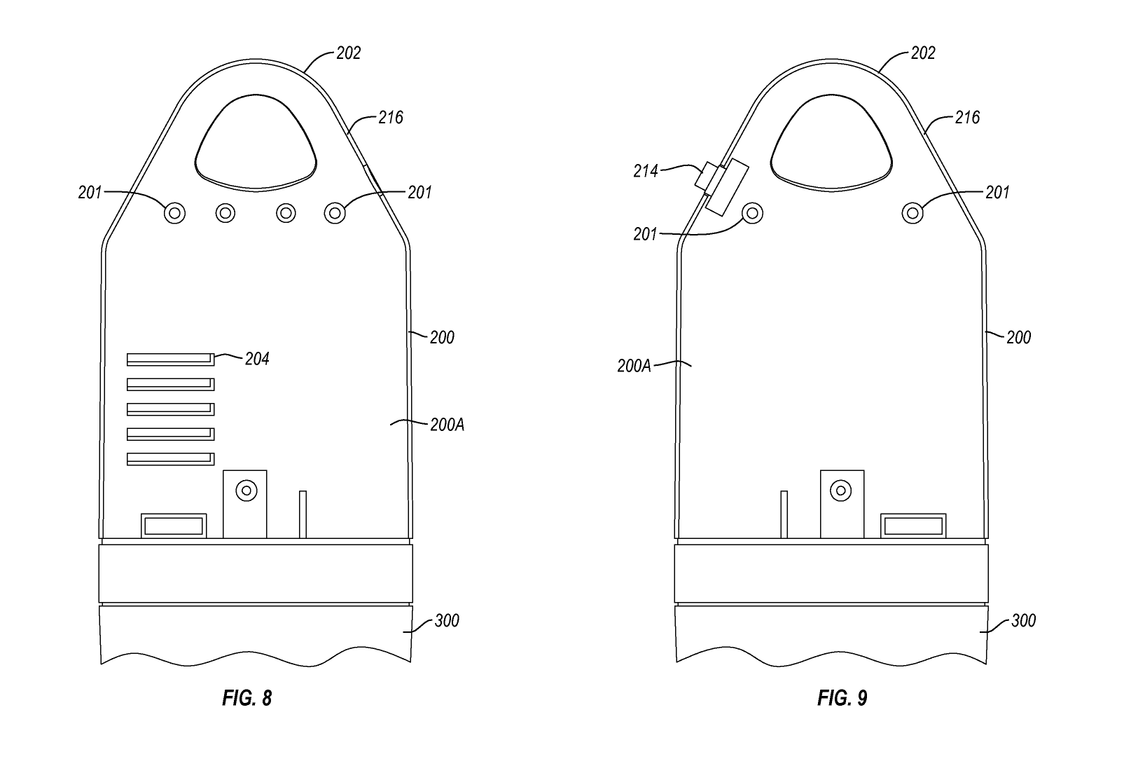

As indicated in FIGS. 8 and 9, the housing 200 defines an interior 200A that is sized and configured to receive various components, including a pump, motor and battery, as discussed below. With particular reference to FIG. 8, it can be seen that the vents 204 are configured and arranged to enable airflow into and out of the interior 200A of the housing 200. As well, and with reference to FIG. 9, the housing 200 may include or define a floor 200B that supports, directly or indirectly, one or more of the components disposed in the interior 200A.

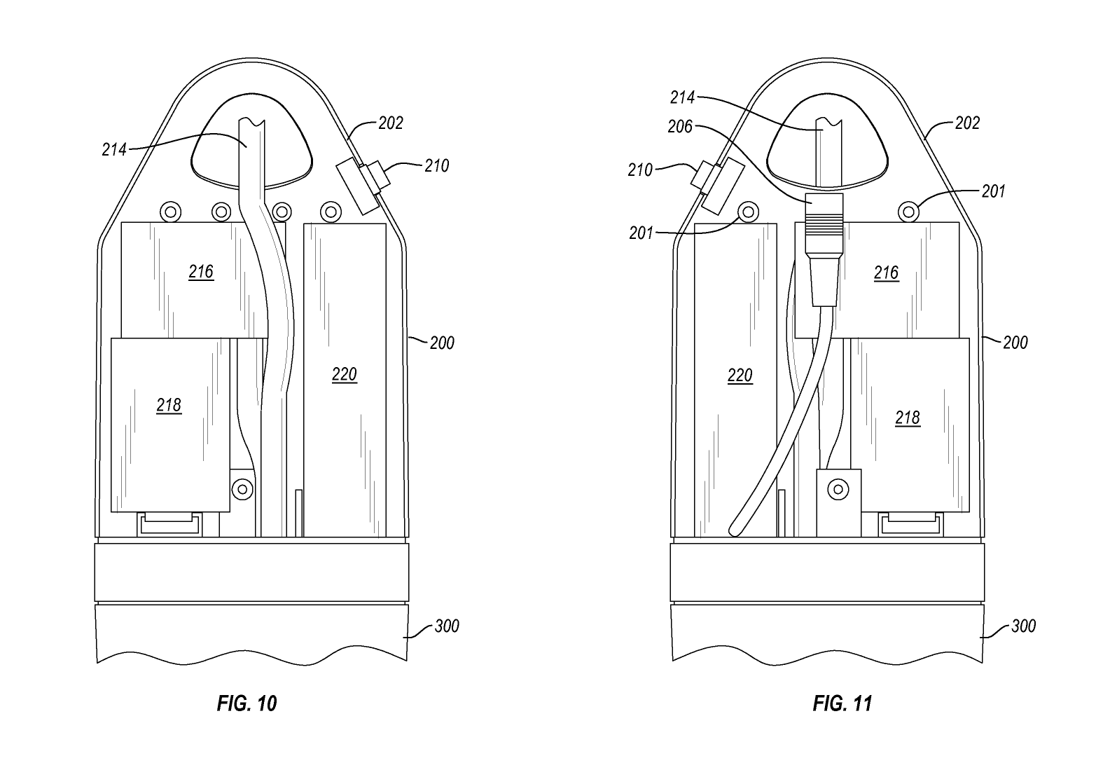

As best shown in FIGS. 10-14, the personal misting device 100 includes a pump 216, pump motor 218, and a power source such as a battery 220 connected to the pump motor 218, one, some or all of which may be substantially disposed within the housing 200. In one alternative embodiment, one or more photovoltaic cells are used in addition to, or as an alternative to, the battery 220. The battery 220 may be rechargeable, but that is not required. As well, the battery 220 may have an associated overcharge protection circuit, although that is not required. Finally, a low battery indicator such as an LED or other type of light source for example, can be connected to the battery 220 to provide a visual indication to a user that the battery 220 is running low on power and needs to be replaced or recharged.

The pump 216 includes outlet and inlet connections 216a and 216b, and may be in fluid communication with a fluid inlet connection 212, for example, by way of which water is pumped out of the reservoir 300, and the pump 216 may also be in fluid communication with the outlet 214, such that the pump 216 can pump fluid from the reservoir 300 and out through the outlet 214. The fluid inlet connection 212 to the pump 216 may be implemented as, or include, a hose similar to the hose 222 discussed below. In any case, the fluid inlet connection 212 may penetrate the floor 200B and, where such a configuration is employed, one or more seals or other elements of comparable functionality may be employed to prevent fluid in the reservoir 300 from entering the interior 200A of the housing 200.

In some embodiments, a plurality of pumps, such as two or more pumps, can be fitted in the housing 200. In similar fashion, a plurality of misting nozzles (discussed below) can be employed in various embodiments. In at least some examples, multiple pumps and multiple misting nozzles are employed in a single embodiment.

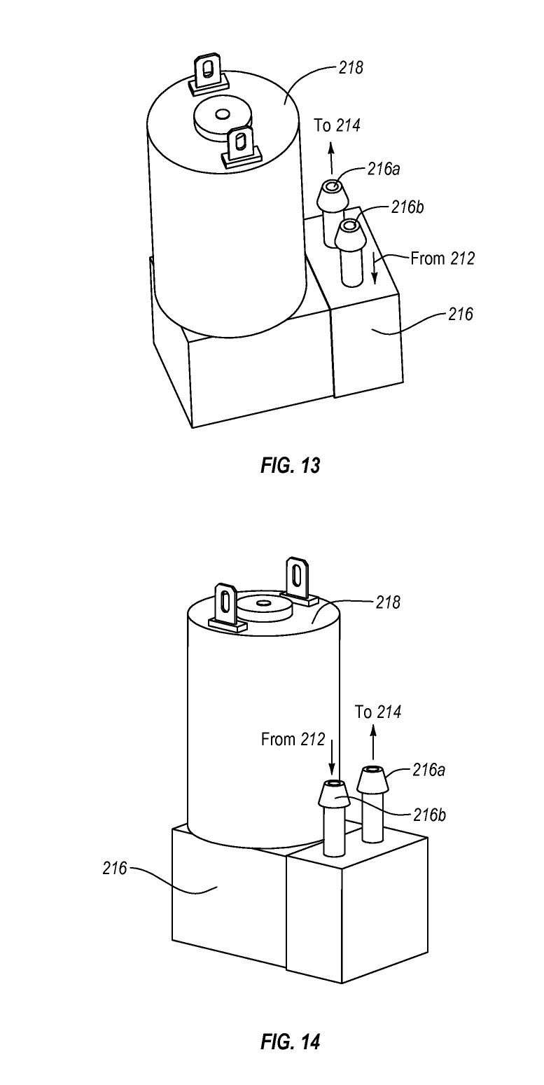

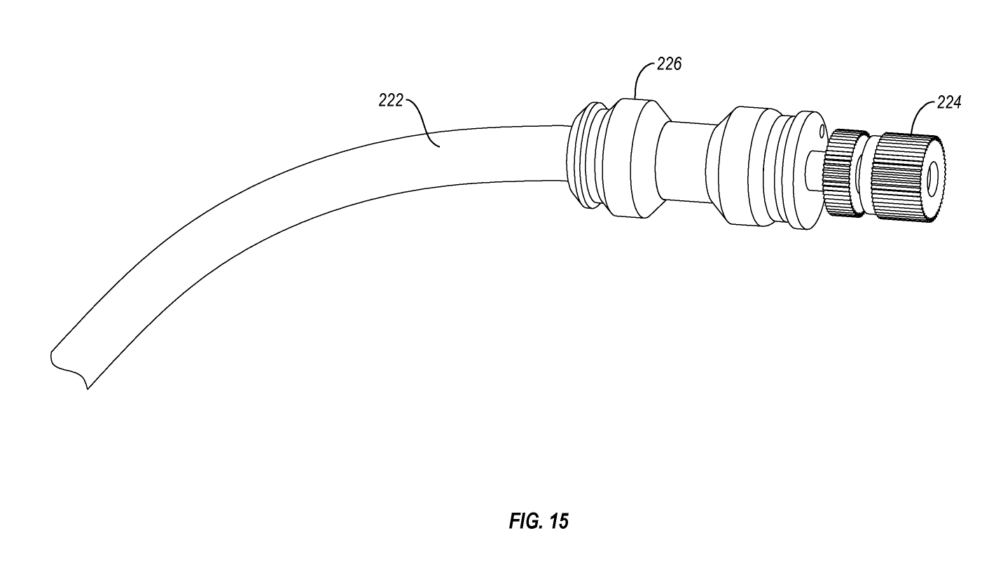

The body of the pump 216 may be substantially composed of plastic. As well, the pump 216 may be configured to operate in a variety of orientations, so that a flow of mist can be provided to the user without regard to the orientation of the personal misting device 100. For example, some embodiments of the pump 216 are operable even if disposed in a vertical orientation that is the reverse of the orientation shown in FIGS. 13 and 14.

At least some embodiments of the pump 216 may, but need not, include a diaphragm that is operable to effect fluid movement, and the diaphragm may be acted upon, directly or indirectly, by one or more magnetic coils such that application of power to the coil(s) results in a corresponding movement of the diaphragm, so as to move fluid through the pump.

Particularly advantageous in at least some embodiments is the very small size of the pump. For example, the pump may be only about 22.7 millimeters high (about 0.89 inches), 22.7 millimeters wide (about 0.89 inches), and about 38.1 millimeters long (about 1.5 inches), although pumps of other dimensions could be used. The pump motor 218 may be similarly compact. For example, one embodiment of the pump motor 218 is about 27.4 mm in diameter, and about 46.6 mm long, although motors of other dimensions could be used.

The pump may weigh about 70 grams or less, and produce a noise level of about 50 dB or less. The small size and weight of the pump, and the small size of the associated battery, facilitate the compact size and portability of the personal misting device. Advantageously, the pump 216 may be quite small, weighing in a range of about 2 oz. to about 3 oz. in some examples, and one particular embodiment of the pump 216 weighs about 2.4 oz.

Due at least in part to the small size of the pump 216, embodiments of the personal misting device 100 may, in turn, have one or more of the following attributes: sufficiently small size to be readily held in one hand of a user; ready portability; relatively light weight; relatively quiet operation; and, relatively low power requirements.

One example embodiment of the pump 216 is pump model number A23 (enhanced version), manufactured by Dongguan ET Mechanical & Electrical Technology Co., LTD, 93, Longhua Road, ZhouWu, Dongchen District, Dongguan City, Guangdong Province, CHINA (phone: 0086 769 2203 1222). Further details concerning an example pump 216 are disclosed in ‘Appendix A’ of, and incorporated in, the US provisional patent application to which the present application claims priority.

It should be noted that while other pumps may exist that can produce a flow of mist, such pumps are likely to be substantially larger and heavier, with correspondingly larger power requirements, and need for heat dissipation, relative to the pumps disclosed herein and, as such, those other pumps would be impractical for use in connection with embodiments of the invention and would render embodiments of the invention unsuitable for their intended purpose and application.

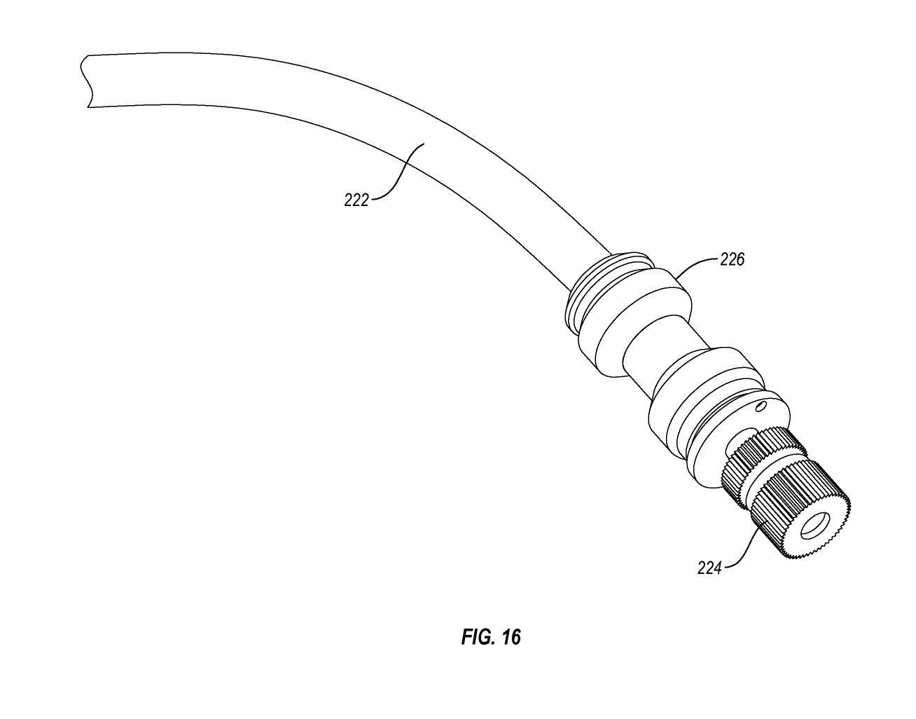

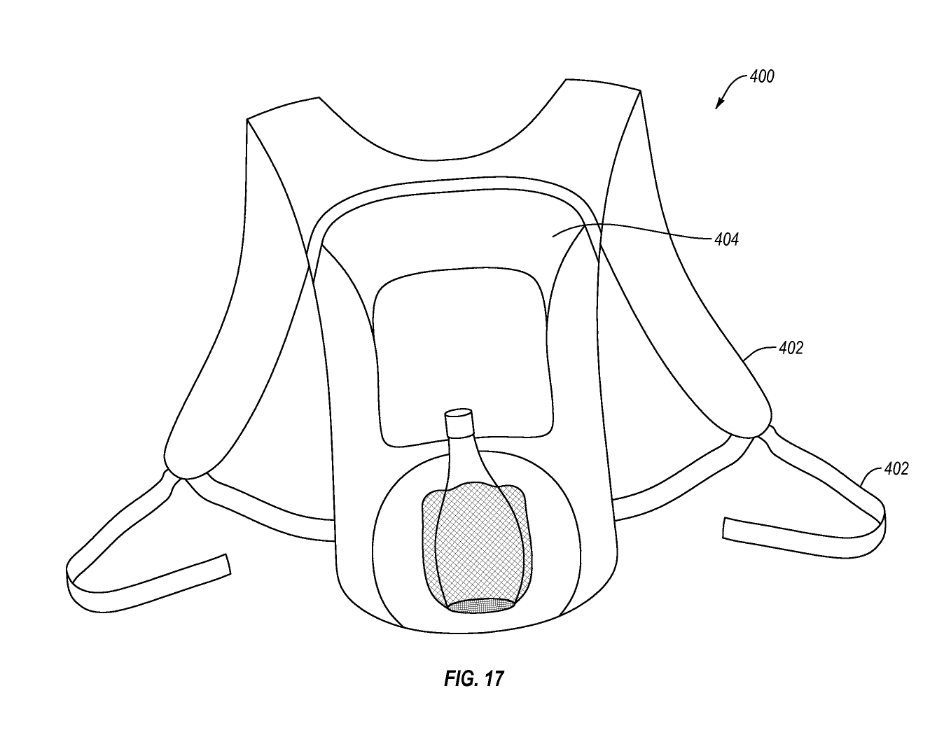

With continued reference now to FIGS. 10-14, and directing attention as well to FIGS. 15-16, the pump 216 outlet connection 216A can be releasably connected to the outlet connection 214, such as by way of a tube for example, and the outlet connection 214 may, in turn, be releasably connected to a hose 222 that terminates in a misting nozzle 224 such that water or other fluid exiting the outlet connection 214 can be directed to the atmosphere by way of the hose 222 and misting nozzle 224. The misting nozzle 224 can comprise brass or any other suitable material(s) and may, in some embodiments, include a filter such as a screen to prevent the ingress of foreign material into the nozzle 224. In one alternative embodiment, the outlet connection 214 may be omitted, and the pump 216 outlet connection 216A can be directly, releasably connected to the misting nozzle 224 by way of the hose 222. It should be noted that any and/or all connections between two or more fluid components of the disclosed embodiments may comprise a quick-disconnect connection. Such fluid components include, but are not limited to, the pump 202, hose 222, misting nozzle 224, outlet connection 214, pump outlet and inlet connections 216a and 216b, and fluid inlet connection 212.

In any case, the hose 222 can be a semi-rigid hose, and may comprise plastic and/or rubber, and/or any other suitable material(s). The hose 222 may be insulated, but that is not required. Among other things, a semi-rigid hose may enable a user to direct a flow of mist in a desired direction in a virtually hands-free operation which does not require the user to continuously hold or point the personal misting device 100. The semi-rigid construction of the hose 222 can be achieved in a variety of ways. By way of illustration, a wire can be attached to the hose 222 and a plastic sheath then shrink wrapped, using heat for example, around the wire and hose 222 so that the wire is securely retained on the hose 222. The wire can be oriented parallel to the hose 222, or wound around the hose 222.

Although the configuration of FIGS. 15 and 16 indicates a single misting nozzle 224, a plurality of misting nozzles can be employed in other embodiments. For example, a tube such as hose 222 may be configured to split into two or more outlets, each in fluid communication with a corresponding misting nozzle. In such embodiments, each misting nozzle may be configured to be independently positioned and oriented so as to enable a user to define multiple customized misting configurations.

In general, any nozzle configured to produce a fluid mist may be employed in connection with one or more embodiments of the invention, and the scope of the invention is not limited to any particular nozzle configuration, size, or type. One example of a misting nozzle 224 is a “quick insert misting nozzle” manufactured by Zhuji Xingye Chemical Fiber Silk Spray Head Factory, No. 38, Meichi Street, Diankou Town, Zhuji City, Zhejiang, China 311814, Telephone Number: 086-575-87205696, 13967565003, Fax Number: 086-575-87493007. Any other misting nozzles of similar construction and functionality may alternatively be employed however.

Finally, the misting nozzle 224 may be connected to the hose 222 by way of a connector fitting 226, which may be a quick connect/disconnect fitting, compression fitting, or any other type of suitable fitting.

Directing attention finally to FIG. 17, details are provided concerning an example apparatus that may be used to transport one or more personal misting devices 100. The apparatus may comprise a backpack 400 with one or more straps 402 or similar elements that enable a user to releasably secure the backpack 400 to his or her body. The backpack 400 may additionally include one or more compartments 404 that can be open, or securable by a zipper or other releasable closure. The compartment(s) 404 may be sized and configured to partially, or completely, accommodate one or more personal misting devices. As well, the backpack 400 may include a hydration bladder (not shown) which can be employed in place of the reservoir 300, and the fluid inlet connection 212 releasably connected to the hydration bladder by way of a hose or other fluid conduit.

C. Operational Aspects of Some Example Embodiments

At least some embodiments of the personal misting device disclosed herein may operate as set forth in the following discussion. In general, activation of the on-off switch 210 causes electrical power from the battery 220 to be provided to the pump 216 to begin operation and pump water or other fluid from the reservoir 300 or external source, such as a hydration bladder, into the inlet 212, through the pump 216 and out through the outlet 214. As the water or other fluid passes through the outlet 214 and through one or more misting nozzles 224 or comparable devices, the water is misted by the misting nozzle 224 and a flow of mist is generated that a user can direct in a desired direction with hose 222. The mist may be provided in a relatively steady stream, or can be pulsed by repeatedly activating the on-off switch 210.

Although this disclosure has been described in terms of certain embodiments, other embodiments apparent to those of ordinary skill in the art are also within the scope of this disclosure.

What is claimed is:

1. A personal misting device, comprising:
a portable housing sized and configured to be held in one hand of a user;
a fluid reservoir configured to be releasably attached to the portable housing;
a fluid pump and motor substantially disposed within the portable housing, and the fluid pump configured and arranged for fluid communication with the fluid reservoir;
a hose having a first end in fluid communication with the fluid pump;
a misting nozzle disposed proximate a second end of the hose; and
a power supply operable to run the fluid pump.

2. The personal misting device as recited in claim 1, wherein the fluid pump is substantially smaller than the portable housing.

3. The personal misting device as recited in claim 1, wherein the fluid pump is located proximate an upper end of the portable housing.

4. The personal misting device as recited in claim 1, wherein the hose is a semi-rigid hose.

5. The personal misting device as recited in claim 1, wherein the portable housing includes a means for releasably attaching the portable housing to an item.

6. The personal misting device as recited in claim 1, wherein the power supply is a rechargeable lithium battery.

7. The personal misting device as recited in claim 1, wherein the power supply is substantially disposed within the portable housing.

8. The personal misting device as recited in claim 1, wherein the fluid reservoir is removably attached to the housing.

9. The personal misting device as recited in claim 1, wherein the fluid pump has any combination of the following operating properties: 12 volt operating voltage; power requirement of about 3 W; electrical current draw of less than about 200 mA; output fluid pressure in the range of about 130 psi to about 175 psi; dry pumping capability; maximum vacuum of less than about −0.35 bar; an outside diameter of about 0.5 inches; or, a length of about 1 inch.

10. The personal misting device as recited in claim 1, wherein the fluid pump is positioned above the motor in the housing.

11. The personal misting device as recited in claim 1, wherein the fluid pump substantially comprises plastic.

12. A personal misting device, comprising:
a portable housing sized and configured to be held in one hand of a user;
a fluid reservoir configured to be releasably attached to the portable housing;
a fluid pump and motor substantially disposed within the portable housing, and the fluid pump configured and arranged for fluid communication with the fluid reservoir;
a hose having a first end in fluid communication with the fluid pump;
a misting nozzle disposed proximate a second end of the hose; and
a power supply operable to run the fluid pump.

13. A kit including the personal misting device of claim 12, and the kit further including one or more of the following, a hydration bladder with or without a drinking tube/valve, a hose for connecting the hydration bladder to the personal misting device, one or more misting nozzles, a battery charger, an AC adapter, and a pack for carrying a hydration bladder.

14. The personal misting device of claim 12, further comprising one or more additional misting nozzles in fluid communication with the hose.

15. The personal misting device of claim 12, wherein the fluid pump substantially comprises plastic.

16. The personal misting device of claim 12, wherein the hose comprises a hose that is at least semi-rigid.

17. The personal misting device of claim 12, wherein the power supply comprises a rechargeable battery.

18. The personal misting device of claim 12, wherein the first end of the hose is connected directly to the fluid pump, and the second end of the hose is connected to the misting nozzle.

19. The personal misting device of claim 12, further comprising an on-off switch operable to control operation of the fluid pump.

20. The personal misting device of claim 12, wherein the power supply is substantially disposed within the housing.
